(19) United States
(12) Patent Application Publication
(10) Pub. No.: US 2025/0063228 A1
(43) Pub. Date: Feb. 20, 2025

(54) CONTENT DISPLAY DEVICE, AND CONTENT DISPLAY METHOD

(71) Applicant: Mitsubishi Electric Corporation, Tokyo (JP)

(72) Inventors: Sayuri FUKANO, Tokyo (JP); Kyosuke ISHII, Tokyo (JP)

(73) Assignee: Mitsubishi Electric Corporation, Tokyo (JP)

(21) Appl. No.: 18/935,772

(22) Filed: Nov. 4, 2024

Related U.S. Application Data
(63) Continuation of application No. PCT/JP2022/022703, filed on Jun. 6, 2022.

(51) Int. Cl. H04N 21/45; H04N 21/414; H04N 21/4223; H04N 21/4415; H04N 21/442

(52) U.S. Cl. CPC H04N 21/4532; H04N 21/41415; H04N 21/4223; H04N 21/4415; H04N 21/44218

(57) ABSTRACT

A content display device includes processing circuitry configured to; acquire sensing information of a sensor that observes a viewing area that is an area where a display is viewable; identify each of two or more users present in the viewing area on a basis of the acquired sensing information, and transmit identification information of each of the users to a personal authentication server; acquire personal information corresponding to identification information of each of the users; determine one or more video content to be included in video content in accordance with each piece of personal information and generate two or more video content; repeat processing of randomly selecting video content to be displayed on the display from two or more pieces of the video content generated; and cause the display to display the selected video content.

### CROSS-REFERENCE TO RELATED APPLICATION

The present application is a continuation of International Application No. PCT/JP2022/022703, filed Jun. 6, 2022, which is incorporated herein by reference in its entirety.

### TECHNICAL FIELD

The present disclosure relates to a content display device and a content display method.

### BACKGROUND ART

There is a display control system that causes a display device to display video content (see, for example, Patent Literature 1). The display control system includes an information processing device and a video output device.

The information processing device specifies an attribute of a person present in a viewing area on the basis of a captured image of the viewing area, which is an area where the display device is viewable. Examples of the attribute of the person include gender, physique, personal belongings, or clothes. The information processing device selects video content corresponding to the attribute of the person from among the plurality of pieces of video content stored in a content storage unit. The video output device causes the display device to display the video content selected by the information processing device.

### CITATION LIST

### Patent Literature

Patent Literature 1: WO 2021/186717

### SUMMARY OF INVENTION

### Technical Problem

The attribute of the person specified by the information processing device of the display control system disclosed in Patent Literature 1 is an attribute that can be specified from the captured image of the viewing area. There is a problem that the information processing device cannot select the video content that the person present in the viewing area is interested in based on only the attribute that can be specified from the captured image.

The present disclosure has been made to solve the above problems, and an object of the present disclosure is to provide a content display device and a content display method capable of generating, for a person present in a viewing area, video content that the person present in the viewing area is interested in by using information of the person other than an attribute that can be specified from a captured image.

### Solution to Problem

A content display device according to the present disclosure includes processing circuitry configured to; acquire sensing information of a sensor that observes a viewing area that is an area where a display is viewable; identify each of two or more users present in the viewing area on a basis of the acquired sensing information, and transmit identification information of each of the users to a personal authentication server that records personal information; acquire personal information corresponding to identification information of each of the users from the personal information recorded in the personal authentication server; determine one or more video content to be included in video content in accordance with each piece of personal information corresponding to personal information of each user, as video content corresponding to each user, and generate two or more video content including the one or more video content; and cause the display to display each piece of the video content having been generated, wherein the processing circuitry repeats processing of randomly selecting video content to be displayed on the display from two or more pieces of the video content having been generated, and causes the display to display the selected video content.

### Advantageous Effects of Invention

According to the present disclosure, it is possible to generate, for a person present in the viewing area, video content in which the person present in the viewing area shows interest by using information on the person other than an attribute that can be specified from a captured image.

### BRIEF DESCRIPTION OF DRAWINGS

FIG. 1 is a configuration diagram illustrating a content display system according to a first embodiment.

FIG. 2 is a configuration diagram illustrating a content display device 2 according to the first embodiment.

FIG. 3 is a hardware configuration diagram illustrating hardware of the content display device 2 according to the first embodiment.

FIG. 4 is a configuration diagram illustrating a personal authentication server 3 according to the first embodiment.

FIG. 5 is a hardware configuration diagram illustrating hardware of the personal authentication server 3 according to the first embodiment.

FIG. 6 is a hardware configuration diagram of a computer in a case where the content display device 2 is implemented by software, firmware, or the like.

FIG. 7 is a hardware configuration diagram of a computer in a case where the personal authentication server 3 is implemented by software, firmware, or the like.

FIG. 8 is a flowchart illustrating a content display method which is a processing procedure performed in the content display device 2.

FIG. 9 is a flowchart illustrating a processing procedure performed in the personal authentication server 3.

FIG. 10 is a configuration diagram illustrating a content display device 2 according to a second embodiment.

FIG. 11 is a hardware configuration diagram illustrating hardware of the content display device 2 according to the second embodiment.

### DESCRIPTION OF EMBODIMENTS

Hereinafter, in order to describe the present disclosure in more detail, modes for carrying out the present disclosure will be described with reference to the accompanying drawings.

### First Embodiment

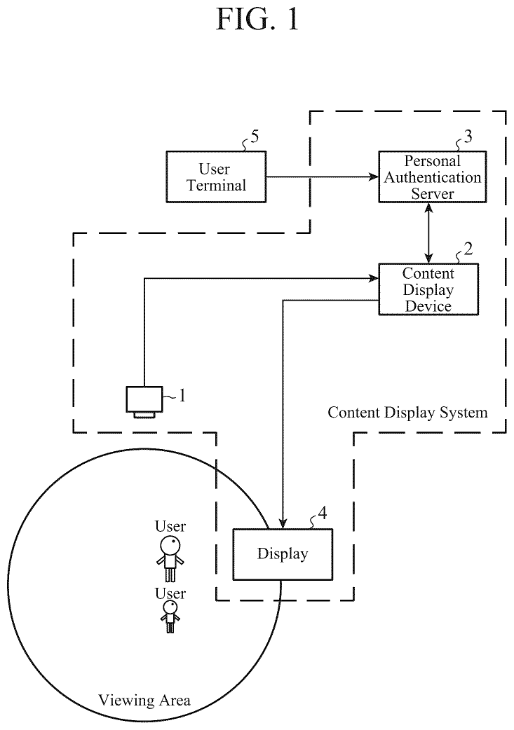

FIG. 1 is a configuration diagram illustrating a content display system according to a first embodiment.

The content display system illustrated in FIG. 1 includes a sensor 1, a content display device 2, a personal authentication server 3, and a display 4.

The sensor 1 is implemented by, for example, a camera.

The sensor 1 observes a viewing area that is an area where the display 4 can be viewed.

The sensor 1 transmits image data indicating a captured image of the viewing area to the content display device 2 as sensing information.

In the content display system illustrated in FIG. 1, the sensor 1 is implemented by a camera. However, this is merely an example, and the sensor 1 may be implemented by, for example, a smartphone or an integrated circuit (IC) card.

In a case where the sensor 1 is implemented by a smartphone or an IC card, the sensor 1 may transmit an identification (ID) of a user recorded in the smartphone or an ID of the user recorded in the IC card to the content display device 2 as sensing information. When the sensor 1 is implemented by, for example, a fingerprint sensor attached to the display 4 or the like, the sensor 1 may transmit fingerprint data to the content display device 2 as sensing information.

The content display device 2 generates video content in accordance with personal information of a person present in the viewing area, and causes the display 4 to display the video content.

The personal authentication server 3 transmits the personal information of the person present in the viewing area to the content display device 2.

The display 4 is installed, for example, near a door in a train, on an information board of a shopping mall, or on an information board of a public facility.

The display 4 displays video content.

A user terminal 5 is a terminal used by the user, and is, for example, a smartphone, a tablet, or a personal computer.

The user terminal 5 causes registration information to be recorded in the personal authentication server 3 by transmitting the registration information including identification information of the user and the personal information of the user to the personal authentication server 3.

The sensor 1 and the content display device 2, the content display device 2 and the personal authentication server 3, the content display device 2 and the display 4, and the personal authentication server 3 and the user terminal 5 are connected to each other via a network. Examples of the network include the Internet, a local area network (LAN), and a telephone communication network.

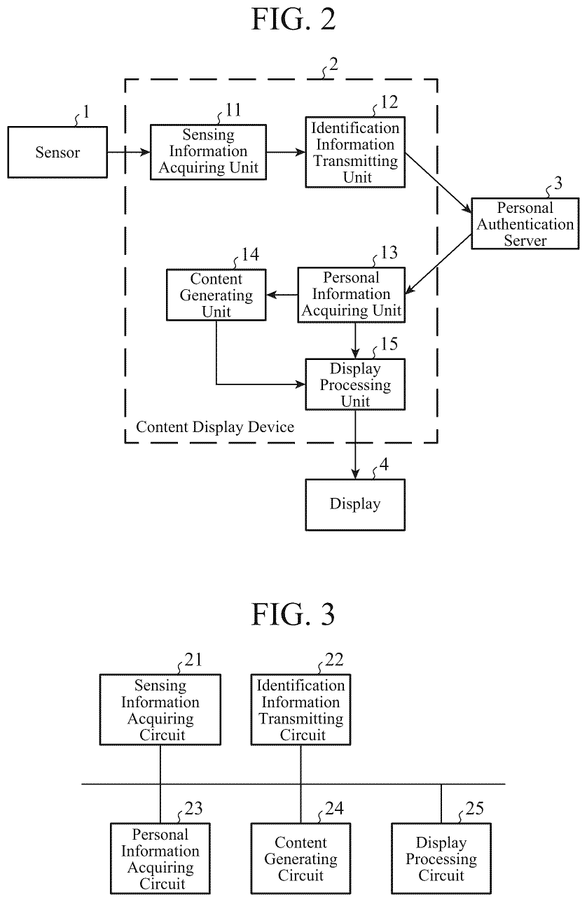

FIG. 2 is a configuration diagram illustrating the content display device 2 according to the first embodiment.

FIG. 3 is a hardware configuration diagram illustrating hardware of the content display device 2 according to the first embodiment.

The content display device 2 illustrated in FIG. 2 includes a sensing information acquiring unit 11, an identification information transmitting unit 12, a personal information acquiring unit 13, a content generating unit 14, and a display processing unit 15.

The sensing information acquiring unit 11 is implemented by, for example, a sensing information acquiring circuit 21 illustrated in FIG. 3.

The sensing information acquiring unit 11 acquires sensing information of the sensor 1 and outputs the sensing information to the identification information transmitting unit 12.

The identification information transmitting unit 12 is implemented by, for example, an identification information transmitting circuit 22 illustrated in FIG. 3.

The identification information transmitting unit 12 identifies each of one or more users present in the viewing area on the basis of the sensing information acquired by the sensing information acquiring unit 11.

The identification information transmitting unit 12 transmits identification information of each user to the personal authentication server 3.

The personal information acquiring unit 13 is implemented by, for example, a personal information acquiring circuit 23 illustrated in FIG. 3.

The personal information acquiring unit 13 acquires personal information corresponding to identification information of each user from the personal information recorded in the personal authentication server 3.

The personal information acquiring unit 13 outputs the personal information corresponding to the identification information of each user to the content generating unit 14.

The content generating unit 14 is implemented by, for example, a content generating circuit 24 illustrated in FIG. 3.

The content generating unit 14 generates video content in accordance with each piece of personal information acquired by the personal information acquiring unit 13. The video content generated by the content generating unit 14 is, for example, video content whose display content changes over time. The display content is set in accordance with each piece of the personal information. However, this is merely an example, and the video content generated by the content generating unit 14 may be, for example, video content of a still image whose display content is determined in accordance with each piece of personal information.

The content generating unit 14 outputs each piece of video content to the display processing unit 15.

The display processing unit 15 is implemented by, for example, a display processing circuit 25 illustrated in FIG. 3.

The display processing unit 15 causes the display 4 to display each piece of video content generated by the content generating unit 14.

Specifically, the display processing unit 15 repeats processing of randomly selecting the video content to be displayed on the display 4 from one or more pieces of the video content generated by the content generating unit 14, and causes the display 4 to display the selected video content.

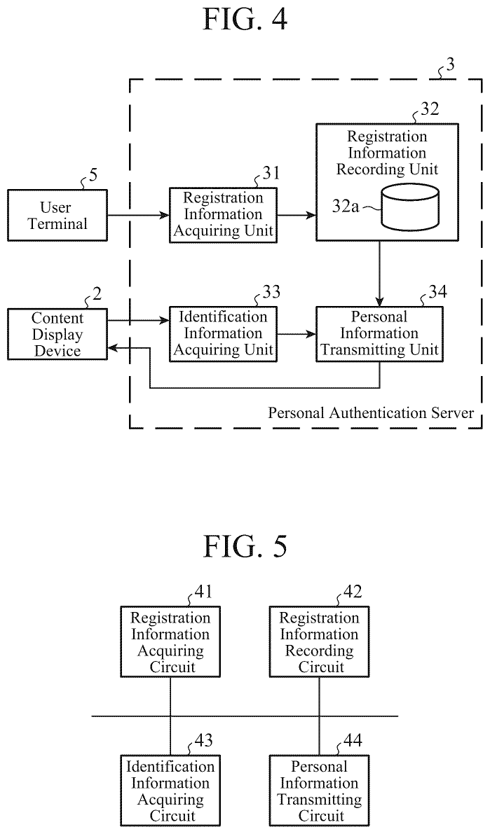

FIG. 4 is a configuration diagram illustrating the personal authentication server 3 according to the first embodiment.

FIG. 5 is a hardware configuration diagram illustrating hardware of the personal authentication server 3 according to the first embodiment.

The personal authentication server 3 illustrated in FIG. 4 includes a registration information acquiring unit 31, a registration information recording unit 32, an identification information acquiring unit 33, and a personal information transmitting unit 34.

The registration information acquiring unit 31 is implemented by, for example, a registration information acquiring circuit 41 illustrated in FIG. 5.

The registration information acquiring unit 31 acquires the identification information of the user and the personal information of the user from the user terminal 5 as registration information.

The registration information acquiring unit 31 outputs the registration information to the registration information recording unit 32.

The registration information recording unit 32 is implemented by, for example, a registration information recording circuit 42 illustrated in FIG. 5.

The registration information recording unit 32 includes a recording medium 32a.

The registration information recording unit 32 records the registration information acquired by the registration information acquiring unit 31.

That is, the registration information recording unit 32 records the registration information acquired by the registration information acquiring unit 31 in the recording medium 32a.

The identification information acquiring unit 33 is implemented by, for example, an identification information acquiring circuit 43 illustrated in FIG. 5.

The identification information acquiring unit 33 acquires the identification information of the user from the content display device 2.

The identification information acquiring unit 33 outputs the identification information of the user to the personal information transmitting unit 34.

The personal information transmitting unit 34 is implemented by, for example, a personal information transmitting circuit 44 illustrated in FIG. 5.

The personal information transmitting unit 34 acquires the identification information of the user from the identification information acquiring unit 33.

The personal information transmitting unit 34 transmits, to the content display device 2, the personal information corresponding to the identification information of the user among the personal information included in the registration information recorded in the registration information recording unit 32.

In FIG. 2, it is assumed that each of the sensing information acquiring unit 11, the identification information transmitting unit 12, the personal information acquiring unit 13, the content generating unit 14, and the display processing unit 15, which are components of the content display device 2, is implemented by dedicated hardware as illustrated in FIG. 3. That is, it is assumed that the content display device 2 is implemented by the sensing information acquiring circuit 21, the identification content generating circuit 24, and the display processing circuit 25.

Each of the sensing information acquiring circuit 21, the identification information transmitting circuit 22, the personal information acquiring circuit 23, the content generating circuit 24, and the display processing circuit 25 corresponds to, for example, a single circuit, a composite circuit, a programmed processor, a parallel-programmed processor, an application specific integrated circuit (ASIC), a field-programmable gate array (FPGA), or a combination thereof.

The components of the content display device 2 are not limited to those implemented by dedicated hardware, and the content display device 2 may be implemented by software, firmware, or a combination of software and firmware.

The software or firmware is stored in a memory of the computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

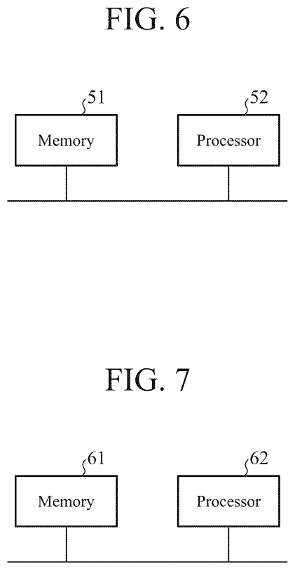

FIG. 6 is a hardware configuration diagram of a computer in a case where the content display device 2 is implemented by software, firmware, or the like.

In a case where the content display device 2 is implemented by software, firmware, or the like, a program for causing a computer to execute respective processing procedures in the sensing information acquiring unit 11, the identification information transmitting unit 12, the personal information acquiring unit 13, the content generating unit 14, and the display processing unit 15 is stored in a memory 51. Then, a processor 52 of the computer executes the program stored in the memory 51.

Furthermore, FIG. 3 illustrates an example in which each of the components of the content display device 2 is implemented by dedicated hardware, and FIG. 6 illustrates an example in which the content display device 2 is implemented by software, firmware, or the like. However, this is merely an example, and some components in the content display device 2 may be implemented by dedicated hardware, and the remaining components may be implemented by software, firmware, or the like.

In FIG. 4, it is assumed that each of the registration information acquiring unit 31, the registration information recording unit 32, the identification information acquiring unit 33, and the personal information transmitting unit 34, which are components of the personal authentication server 3, is implemented by dedicated hardware as illustrated in FIG. 5. That is, it is assumed that the personal authentication server 3 is implemented by the registration information acquiring circuit 41, the registration information recording circuit 42, the identification information acquiring circuit 43, and the personal information transmitting circuit 44.

The registration information recording circuit 42 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Each of the registration information acquiring circuit 41, the identification information acquiring circuit 43, and the personal information transmitting circuit 44 corresponds to, for example, a single circuit, a composite circuit, a programmed processor, a parallel-programmed processor, ASIC, FPGA, or a combination thereof.

The components of the personal authentication server 3 are not limited to those implemented by dedicated hardware, and the personal authentication server 3 may be implemented by software, firmware, or a combination of software and firmware.

FIG. 7 is a hardware configuration diagram of a computer in a case where the personal authentication server 3 is implemented by software, firmware, or the like.

In a case where the personal authentication server 3 is implemented by software, firmware, or the like, the registration information recording unit 32 is configured on a memory 61 of the computer. A program for causing a computer to execute each processing procedure in the registration information acquiring unit 31, the identification information acquiring unit 33, and the personal information transmitting unit 34 is stored in the memory 61. Then, a processor 62 of the computer executes the program stored in the memory 61.

In addition, FIG. 5 illustrates an example in which each of the components of the personal authentication server 3 is implemented by dedicated hardware, and FIG. 7 illustrates an example in which the personal authentication server 3 is implemented by software, firmware, or the like. However, this is merely an example, and some components in the personal authentication server 3 may be implemented by dedicated hardware, and the remaining components may be implemented by software, firmware, or the like.

Next, an operation of the content display system illustrated in FIG. 1 will be described.

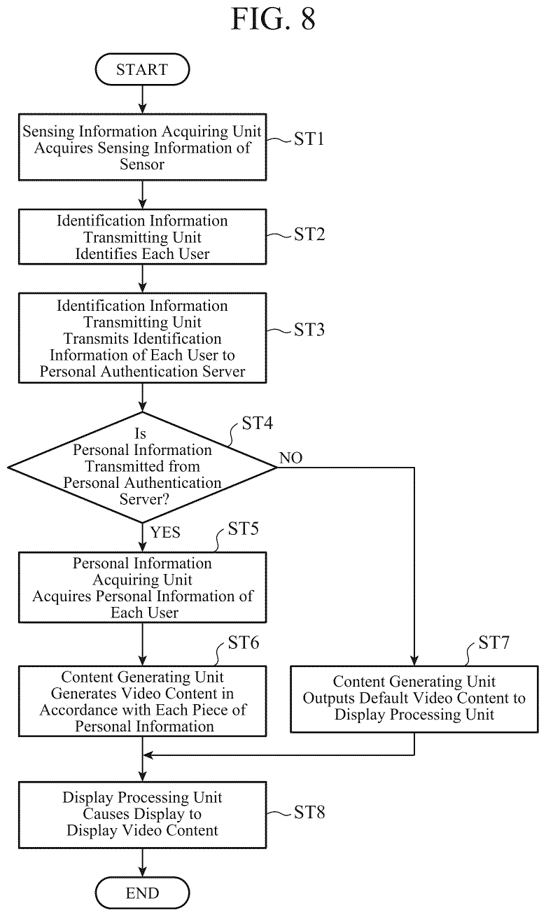

FIG. 8 is a flowchart illustrating a content display method that is a processing procedure performed in the content display device 2.

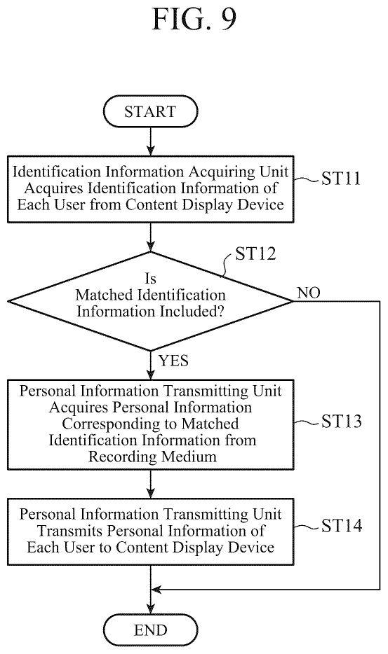

FIG. 9 is a flowchart illustrating the processing procedure performed in the personal authentication server 3.

In the content display system illustrated in FIG. 1, the personal information of the user needs to be registered in the personal authentication server 3 in advance. The registration of the personal information is usually performed before the user enters the viewing area.

Hereinafter, a processing procedure when the personal information is registered in the personal authentication server 3 will be described.

First, the user operates the user terminal 5 to access the personal authentication server 3, and performs user registration with respect to the personal authentication server 3.

Specifically, the user operates the user terminal 5 to set, for example, an identification (ID) and a password in the personal authentication server 3.

Further, the user operates the user terminal 5 to set identification information of the user in the personal authentication server 3.

A previously set ID may be used as the identification information of the user, but for example, a face image of the user, a fingerprint image of the user, or an iris image of the user may be used as the identification information of the user.

In a case where the face image of the user, the fingerprint image of the user, or the iris image of the user is used as the identification information of the user, the user captures the face image of the user, the fingerprint image of the user, or the iris image of the user. For capturing the face image or the like, a camera mounted on the user terminal 5 may be used, or a camera different from the camera mounted on the user terminal 5 may be used.

Furthermore, for example, conversion data from the face image of the user, conversion data from the fingerprint image of the user, or conversion data from the iris image of the user may be used as the identification information of the user. As the conversion data, for example, there is data obtained by encrypting image data indicating a face image, image data indicating a fingerprint image, or image data indicating an iris image. Furthermore, as the conversion data, for example, there is data obtained by removing a part of image data indicating a face image or the like. Use of the conversion data is more desirable than use of an image itself such as a face image in order to protect privacy of the individual.

After the user registration with respect to the personal authentication server 3 is completed, the user operates the user terminal 5 to transmit the ID and the password to the personal authentication server 3, thereby logging in to the personal authentication server 3.

When logging in to the personal authentication server 3, the user operates the user terminal 5, and transmits the identification information of the user and the personal information of the user to the personal authentication server 3 as the registration information.

In a case where the face image, the fingerprint image, or the iris image is used as the identification information of the user, the identification information included in the registration information is image data indicating the face image, the fingerprint image, or the iris image.

Furthermore, in a case where conversion data from a face image, conversion data from a fingerprint image, or conversion data from an iris image is used as the identification information of the user, the identification information included in the registration information is conversion data from a face image, conversion data from a fingerprint image, or conversion data from an iris image.

Examples of the personal information of the user include a name, an age, an annual income, a place of employment, a service years, a school name and grade, an address, a family structure, a hobby, belongings, an asset, a favorite dress, and a favorite tourist spot. The personal information illustrated here is merely an example, and may be other personal information. Examples of the belongings include an automobile, a watch, a smartphone, and a precious metal. An address, a family structure, a hobby, belongings, an asset, a favorite dress, a favorite tourist spot, or the like is personal information that cannot be specified from the captured image of the viewing area.

The registration information acquiring unit 31 of the personal authentication server 3 acquires the identification information of the user and the personal information of the user from the user terminal 5.

The registration information acquiring unit 31 outputs the registration information to the registration information recording unit 32.

The registration information recording unit 32 acquires the registration information from the registration information acquiring unit 31, and records the registration information in the recording medium 32a.

Next, a processing procedure when the content display device 2 causes the display 4 to display the video content will be described.

The sensor 1 observes a viewing area that is an area where the display 4 can be viewed. In a case where the display 4 is installed, for example, above a door in a train, a peripheral area of the door is the viewing area. In addition, when the display 4 is installed, for example, on an information board of a shopping mall, a fan-shaped area several meters from the information board is the viewing area.

In a case where the sensor 1 is implemented by a camera, the sensor 1 transmits image data indicating a captured image of the viewing area to the content display device 2 as sensing information.

The sensing information acquiring unit 11 acquires image data indicating a captured image of the viewing area as sensing information of the sensor 1 (step ST1 in FIG. 8).

The sensing information acquiring unit 11 outputs the image data as sensing information to the identification information transmitting unit 12.

The identification information transmitting unit 12 acquires the image data as sensing information from the sensing information acquiring unit 11.

The identification information transmitting unit 12 identifies each user present in the viewing area by performing image processing on the captured image indicated by the image data (step ST2 in FIG. 8).

In the content display system illustrated in FIG. 1, since two users are present in the viewing area, the identification information transmitting unit 12 identifies each of the two users. When three or more users are present in the viewing area, the identification information transmitting unit 12 identifies each of the three or more users.

Specifically, the identification information transmitting unit 12 extracts, for example, a face image, a fingerprint image, or an iris image of each user from the captured image as identification information of each user by performing image processing on the captured image.

The identification information transmitting unit 12 transmits the identification information of each user to the personal authentication server 3 (step ST3 in FIG. 8).

Here, the identification information transmitting unit 12 extracts a face image, a fingerprint image, or an iris image of each user from the captured image as the identification information of each user. The identification information transmitting unit 12 performs an encryption process on image data indicating the face image or the like, thereby generating encrypted data as conversion data from the face image or the like. Then, the identification information transmitting unit 12 may transmit the conversion data of each user to the personal authentication server 3 as the identification information of each user.

When the sensing information of the sensor 1 is the ID of the user recorded in the smartphone or the like, the identification information transmitting unit 12 may transmit the ID of each user to the personal authentication server 3 as the identification information of each user.

The identification information acquiring unit 33 of the personal authentication server 3 acquires the identification information of each user from the content display device 2 (step ST11 in FIG. 9).

The identification information acquiring unit 33 outputs the identification information of each user to the personal information transmitting unit 34.

The personal information transmitting unit 34 acquires identification information of each user from the identification information acquiring unit 33.

The personal information transmitting unit 34 collates each of the plurality of pieces of identification information recorded in the recording medium 32a with the identification information of the user.

Specifically, when the identification information of the user is, for example, image data indicating a face image of the user, the face image indicated by each of a plurality of pieces of image data recorded in the recording medium 32a is collated with the face image of the user. When the identification information of the user is, for example, image data indicating a fingerprint image of the user, the fingerprint image indicated by each of the plurality of pieces of image data recorded in the recording medium 32a is collated with the fingerprint image of the user. When the identification information of the user is, for example, image data indicating the iris image of the user, the iris image indicated by each of the plurality of pieces of image data recorded in the recording medium 32a is collated with the iris image of the user. When the identification information of the user is, for example, the ID of the user, each of the plurality of IDs recorded in the recording medium 32a is collated with the ID of the user. When the identification information of the user is, for example, conversion data from the face image of the user or the like, each of the plurality of pieces of conversion data recorded in the recording medium 32a is collated with the conversion data of the user.

When the identification information matched with the identification information of each user is included in the plurality of pieces of identification information recorded in the recording medium 32a (in the case of step ST12: YES in FIG. 9), the personal information transmitting unit 34 acquires the personal information corresponding to the matched identification information from the recording medium 32a (step ST13 in FIG. 9).

The personal information transmitting unit 34 transmits the acquired personal information of each user to the content display device 2 (step ST14 in FIG. 9).

When the identification information matched with the identification information of each user is not included in the plurality of pieces of identification information recorded in the recording medium 32a (in the case of step ST12: NO in FIG. 9), the personal information transmitting unit 34 does not transmit the personal information of each user to the content display device 2.

When the personal information corresponding to the identification information of each user is transmitted from the personal authentication server 3 (in the case of step ST4: YES in FIG. 8), the personal information acquiring unit 13 of the content display device 2 acquires the personal information corresponding to the identification information of each user (in the case of step ST5 in FIG. 8).

The personal information acquiring unit 13 outputs the personal information corresponding to the identification information of each user to the content generating unit 14.

When acquiring the personal information corresponding to the identification information of each user from the personal information acquiring unit 13, the content generating unit 14 generates the video content in accordance with each piece of personal information (step ST6 in FIG. 8).

The content generating unit 14 outputs each piece of video content to the display processing unit 15.

When the personal information corresponding to the identification information of each user is not transmitted from the personal authentication server 3 (in the case of step ST4: NO in FIG. 8), the content generating unit 14 outputs default video content to the display processing unit 15 (step ST7 in FIG. 8).

Hereinafter, a generation example of the video content by the content generating unit 14 will be described.

Here, for convenience of description, it is assumed that two users present in the viewing area, one user is Y1, and the other user is Y2.

For example, when the video content is video content for travel promotion by a travel agency, the content generating unit 14 generates video content for travel promotion in which the user Y1 shows interest based on the personal information of the user Y1, and generates video content for travel promotion in which the user Y2 shows interest based on the personal information of the user Y2.

Specifically, the content generating unit 14 extracts, for example, personal information indicating annual income, hobby, and favorite tourist spot from the personal information of the users Y1 and Y2.

Next, the content generating unit 14 determines a favorite tourist spot indicated by the personal information or a tourist spot similar to the favorite tourist spot as a travel destination to be posted in the video content. When the favorite tourist spot of the user Y1 is an overseas island, for example, Hawaii or Bali is determined as the travel destination. When the favorite tourist spot of the user Y2 is a historical scenic spot, for example, Kyoto or Nara is determined as the travel destination.

The content generating unit 14 determines a transportation means to the travel destination in accordance with the annual income of the users Y1 and Y2. For example, when the annual income of the user Y1 is a high income of ooo yen or more, the transportation means to the travel destination is determined to be business class or higher of an airplane. when the annual income of the user Y1 is a medium income of about ΔΔΔ yen, the transportation means to the travel destination is determined to be economy class.

when the annual income of the user Y2 is a high income of ooo yen or more, the transportation means to the travel destination is determined as a green car on the Shinkansen. when the annual income of the user Y2 is a medium income of about ΔΔΔ yen, the transportation means to the travel destination is determined as a reserved seat on the Shinkansen.

The content generating unit 14 determines an activity after movement in accordance with the hobbies of the users Y1 and Y2. For example, when the hobby of the user Y1 is marine diving, the activity after movement is determined to be marine diving. When the hobby of the user Y2 is food tour, the activity after movement is determined to be food tour.

In this case, the content generating unit 14 generates, as the video content for the user Y1, video content including a video of movement to Hawaii or the like in business class or economy class on an airplane, and a video of marine diving in Hawaii or the like.

The content generating unit 14 generates, as video content for the user Y2, video content including a video of movement to Kyoto or the like on a green car or a reserved seat on the Shinkansen and a video of a food tour in Kyoto or the like.

For example, when the video content is video content for advertisement of an apartment by a real estate company, the content generating unit 14 generates video content for advertisement of an apartment in which the user Y1 shows interest on the basis of personal information of the user Y1, and generates video content for advertisement of an apartment in which the user Y2 shows interest on the basis of personal information of the user Y2.

Specifically, the content generating unit 14 extracts, for example, personal information indicating an annual income, an address, and a family structure from the personal information of the users Y1 and Y2.

The content generating unit 14 determines the grade of the apartment to be advertised in accordance with the annual income of the users Y1 and Y2. For example, when the annual income of the user Y1 is a high income of ooo yen or more, the advertisement target apartment is determined to be the highest grade apartment. When the annual income of the user Y2 is a medium income of about ΔΔΔ yen, the advertisement target apartment is determined as a medium-grade apartment.

The content generating unit 14 determines the location of the apartment to be advertised in accordance with the addresses of the users Y1 and Y2. For example, when the address of the user Y1 is in an area along ⋄⋄ line, the advertisement target apartment is determined to be an apartment located in the same area along line or an apartment located in an area along ⊙⊙ line where a transfer is convenient from ⋄⋄ line.

When the address of the user Y2 is an area along □□ line, the advertisement target apartment is determined to be an apartment located in the same area along □□ line or an apartment located in an area along the ⋆⋆⋆ line where it is convenient to transfer from on line.

The content generating unit 14 determines the number of rooms of the apartment to be advertised in accordance with the family structure of the users Y1 and Y2. For example, when the family structure of the user Y1 is a family of four, the number of rooms of the apartment to be advertised is determined to be 3LDK or more. When the family structure of the user Y2 is a family of two, the number of rooms of the apartment to be advertised is determined to be 2DK or more.

In this case, the content generating unit 14 generates, as video content for the user Y1, video content for guiding a highest-grade apartment that is located in an area along ⋄⋄ line or an area along ⊙⊙ line and has 3LDK or more rooms.

The content generating unit 14 generates, as video content for the user Y2, video content for guiding a middle-grade apartment that is located in an area along □□ line or an area along ⋆⋆ line and has 2DK or more rooms. The video content that guides the apartment is, for example, a video that shows the appearance, interior, or peripheral facilities of the apartment.

The display control system disclosed in Patent Literature 1 specifies an attribute of a person present in the viewing area on the basis of a captured image of the viewing area, and selects video content corresponding to the attribute of the person from among a plurality of pieces of video content. However, when a plurality of persons is present in the viewing area, even if attributes determined from the appearances of the plurality of persons are common, the plurality of persons is not necessarily interested in the same thing. For this reason, the display control system may not be able to select the video content in which the person present in the viewing area shows interest.

On the other hand, the content generating unit 14 generates the video content in which the person shows interest on the basis of the personal information including the information other than the attribute determined from the appearance of the person.

The display processing unit 15 acquires one or more pieces of video content from the content generating unit 14. For example, when the users Y1 and Y2 are present in the viewing area, the display processing unit 15 acquires the video content for the user Y1 and the video content for the user Y2 from the content generating unit 14. However, in a case where the personal information of the user Y1 or the like cannot be obtained, the display processing unit 15 acquires the default video content from the content generating unit 14.

The display processing unit 15 repeatedly performs processing of randomly selecting video content to be displayed on the display 4 from one or more pieces of video content.

Every time the video content is selected, the display processing unit 15 causes the display 4 to display the selected video content (step ST8 in FIG. 8).

The video content to be displayed on the display 4 is randomly selected. Further, the video content is generated on the basis of personal information that cannot be specified from the captured image. Therefore, when a plurality of users is present in the viewing area, each user can recognize the video content addressed to the user, and it is difficult to determine to whom the video content addressed to other than the user is addressed. Therefore, the privacy of each user is less likely to be violated.

In the first embodiment described above, the content display device 2 is configured to include the sensing information acquiring unit 11 to acquire sensing information of the sensor 1 that observes a viewing area that is an area where the display 4 is viewable, the identification information transmitting unit 12 to identify each of one or more users present in the viewing area on the basis of the sensing information acquired by the sensing information acquiring unit 11 and transmit identification information of each of the users to the personal authentication server 3 that records personal information; and the personal information acquiring unit 13 to acquire personal information corresponding to identification information of each of the users from the personal information recorded in the personal authentication server 3. Further, the content display device 2 also includes the content generating unit 14 to generate video content in accordance with each piece of personal information acquired by personal information acquiring unit 13, and the display processing unit 15 to cause the display 4 to display each piece of the video content generated by the content generating unit 14. Therefore, regarding a person present in the viewing area, the content display device 2 can generate video content in which the person present in the viewing area shows interest using information of the person other than an attribute that can be specified from a captured image.

Further, in the first embodiment, the personal authentication server 3 is configured to include the registration information acquiring unit 31 that acquires the identification information of the user and the personal information of the user as registration information from the user terminal 5, and the registration information recording unit 32 that records the registration information acquired by the registration information acquiring unit 31. In addition, the personal authentication server 3 includes the identification information acquiring unit 33 to acquire identification information of the user from the content display device 2, and a personal information transmitting unit 34 to transmit, to the content display device 2, personal information corresponding to the identification information acquired by identification information acquiring unit 33 among the personal information included in the registration information recorded in the registration information recording unit 32. Therefore, regarding a person present in the viewing area, the personal authentication server 3 can transmit information on the person other than an attribute that can be specified from a captured image to the content display device 2.

### Second Embodiment

In a second embodiment, a content display device 2 including a viewing time measuring unit 16 that measures a viewing time of each user on the basis of sensing information acquired by the sensing information acquiring unit 11 will be described.

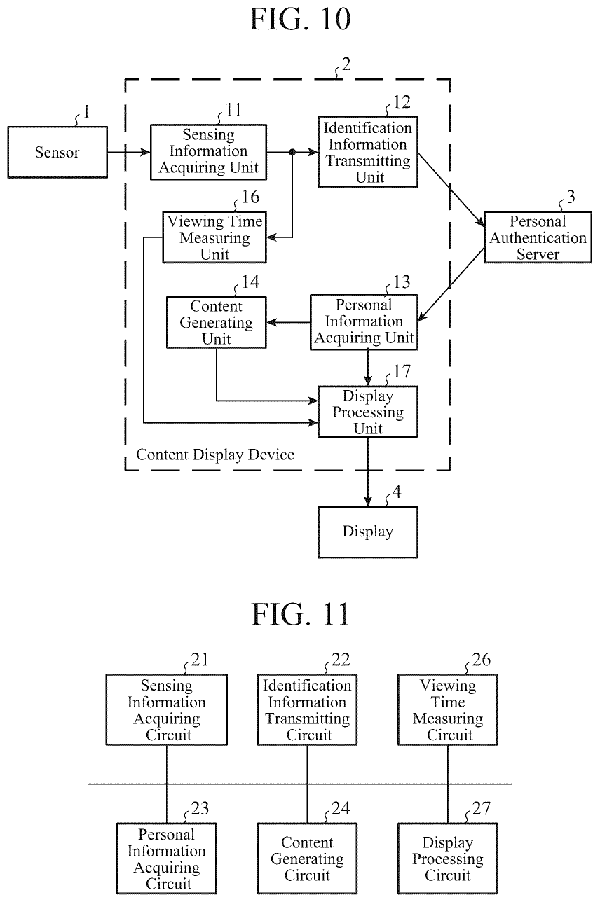

FIG. 10 is a configuration diagram illustrating the content display device 2 according to the second embodiment. In FIG. 10, the same reference numerals as those in FIG. 2 denote the same or corresponding parts, and thus description thereof is omitted.

FIG. 11 is a hardware configuration diagram illustrating hardware of the content display device 2 according to the second embodiment. In FIG. 11, the same reference numerals as those in FIG. 3 denote the same or corresponding parts, and thus description thereof is omitted.

The content display device 2 illustrated in FIG. 10 includes a sensing information acquiring unit 11, an identification information transmitting unit 12, a personal information acquiring unit 13, a content generating unit 14, a viewing time measuring unit 16, and a display processing unit 17.

The viewing time measuring unit 16 is implemented by, for example, a viewing time measuring circuit 26 illustrated in FIG. 11.

The viewing time measuring unit 16 measures a viewing time of each user on the basis of the sensing information acquired by the sensing information acquiring unit 11.

The viewing time measuring unit 16 outputs the viewing time of each user to the display processing unit 17.

The display processing unit 17 is implemented by, for example, a display processing circuit 27 illustrated in FIG. 11.

The display processing unit 17 selects video content to be displayed on the display 4 from among one or more pieces of video content generated by the content generating unit 14 on the basis of the viewing time of each user measured by the viewing time measuring unit 16.

The display processing unit 17 causes the display 4 to display the selected video content.

The configuration of the content display system according to the second embodiment is similar to the configuration of the content display system according to the first embodiment. Thus, a configuration diagram illustrating the content display system according to the second embodiment is illustrated in FIG. 1.

In FIG. 10, it is assumed that each of the sensing information acquiring unit 11, the identification information transmitting unit 12, the personal information acquiring unit 13, the content generating unit 14, the viewing time measuring unit 16, and the display processing unit 17, which are components of the content display device 2, is implemented by dedicated hardware as illustrated in FIG. 11. That is, it is assumed that the content display device 2 is implemented by the sensing information acquiring circuit 21, the identification information transmitting circuit 22, the personal information acquiring circuit 23, the content generating circuit 24, the viewing time measuring circuit 26, and the display processing circuit 27.

Each of the sensing information acquiring circuit 21, the identification content generating circuit 24, the viewing time measuring circuit 26, and the display processing circuit 27 corresponds to, for example, a single circuit, a composite circuit, a programmed processor, a parallel-programmed processor, ASIC, FPGA, or a combination thereof.

The components of the content display device 2 are not limited to those implemented by dedicated hardware, and the content display device 2 may be implemented by software, firmware, or a combination of software and firmware.

In a case where the content display device 2 is implemented by software, firmware, or the like, a program for causing a computer to execute respective processing procedures in the sensing information acquiring unit 11, the identification information transmitting unit 12, the personal information acquiring unit 13, the content generating unit 14, the viewing time measuring unit 16, and the display processing unit 17 is stored in the memory 51 illustrated in FIG. 6. Then, the processor 52 illustrated in FIG. 6 executes the program stored in the memory 51.

Furthermore, FIG. 11 illustrates an example in which each of the components of the content display device 2 is implemented by dedicated hardware, and FIG. 6 illustrates an example in which the content display device 2 is implemented by software, firmware, or the like. However, this is merely an example, and some components in the content display device 2 may be implemented by dedicated hardware, and the remaining components may be implemented by software, firmware, or the like.

Next, an operation of the content display system according to the second embodiment will be described. However, the content display system is similar to the content display system according to the first embodiment except for the viewing time measuring unit 16 and the display processing unit 17 of the content display device 2. Therefore, here, the operations of the viewing time measuring unit 16 and the display processing unit 17 will be mainly described.

The viewing time measuring unit 16 acquires, for example, image data as sensing information from the sensing information acquiring unit 11.

The viewing time measuring unit 16 detects the line of sight of each user present in the viewing area by performing image processing on the captured image indicated by the image data. Processing of detecting the line of sight of the user is a known technique, and thus detailed description thereof will be omitted.

The viewing time measuring unit 16 measures a time during which each user's line of sight faces the display 4 as a viewing time of each user for the video content displayed on the display 4. It is assumed that the longer the viewing time of the user, the higher the user's interest in the video content.

The viewing time measuring unit 16 outputs the viewing time of each user to the display processing unit 17.

The display processing unit 17 acquires the viewing time of each user from the viewing time measuring unit 16.

Further, the display processing unit 17 acquires one or more pieces of video content from the content generating unit 14.

The display processing unit 17 selects video content to be displayed on the display 4 from the one or more pieces of video content on the basis of the viewing time of each user.

For example, when the user Y1 and the user Y2 are present in the viewing area, if the viewing time of the user Y1 is T1 and the viewing time of the user Y2 is T2, the display processing unit 17 calculates a ratio R1 of selecting the video content to the user Y1 as illustrated in the following Formula (1).

Furthermore, the display processing unit 17 calculates a ratio R2 of selecting the video content to the user Y2 as expressed by the following Formula (2).

$$R 1 = \frac{T 1}{T 1 + T 2} \times 100 [ \% ] \qquad ( 1 )$$

$$R 2 = \frac{T 2}{T 1 + T 2} \times 100 [ \% ] \qquad ( 2 )$$

The display processing unit 17 determines a time for selecting the video content for the user Y1 in accordance with the ratio R1, and determines a time of selecting the video content for the user Y2 in accordance with the ratio R2, out of the video content for the user Y1 and the video content for the user Y2.

The display processing unit 17 causes the display 4 to display the selected video content.

In the second embodiment described above, the content display device 2 is configured to include the viewing time measuring unit 16 to measure a viewing time of each of the users on the basis of the sensing information acquired by the sensing information acquiring unit 11, and the display processing unit 17 selects video content to be displayed on the display 4 from among one or more pieces of video content generated by the content generating unit 14 on the basis of the viewing time of each of the users measured by the viewing time measuring unit 16. Therefore, regarding a person present in the viewing area, the content display device 2 according to the second embodiment can generate video content in which the person present in the viewing area shows interest using information of the person other than an attribute that can be specified from a captured image. In addition, the content display device 2 according to the second embodiment can increase a ratio of displaying, on the display 4, video content addressed to a person who shows more interest than the content display device 2 according to the first embodiment.

Note that, in the present disclosure, free combinations of the embodiments, modifications of any components of the embodiments, or omissions of any components in the embodiments are possible.

### INDUSTRIAL APPLICABILITY

The present disclosure is suitable for a content display device, a content display method, and a personal authentication server.

### REFERENCE SIGNS LIST

1: sensor, 2: content display device, 3: personal authentication server, 4: display, 5: user terminal, 11: sensing information acquiring unit, 12: identification information transmitting unit, 13: personal information acquiring unit, 14: content generating unit, 15: display processing unit, 16: viewing time measuring unit, 17: display processing unit, 21: sensing information acquiring circuit, 22: identification information transmitting circuit, 23: personal information acquiring circuit, 24: content generating circuit, 25: display processing circuit, 26: viewing time measuring circuit, 27: display processing circuit, 31: registration information acquiring unit, 32: registration information recording unit, 32a: recording medium, 33: identification information acquiring unit, 34: personal information transmitting unit, 41: registration information acquiring circuit, 42: registration information recording circuit, 43: identification information acquiring circuit, 44: personal information transmitting circuit, 51: memory, 52: processor, 61: memory, 62: processor

1. A content display device comprising:
processing circuitry configured to
acquire sensing information of a sensor that observes a viewing area that is an area where a display is viewable;
identify each of two or more users present in the viewing area on a basis of the acquired sensing information, and transmit identification information of each of the users to a personal authentication server that records personal information;
acquire personal information corresponding to identification information of each of the users from the personal information recorded in the personal authentication server;
determine one or more video content to be included in video content in accordance with each piece of personal information corresponding to personal information of each user, as video content corresponding to each user; and generate two or more video content including the one or more video content; and
cause the display to display each piece of the video content having been generated,
wherein the processing circuitry repeats processing of randomly selecting video content to be displayed on the display from two or more pieces of the video content having been generated, and causes the display to display the selected video content.

2. The content display device according to claim 1, wherein
the processing circuitry generates video content whose display content changes over time in accordance with each piece of personal information having been acquired.

3. The content display device according to claim 1,
wherein the processing circuitry is further configured to
measure a viewing time of each of the users on a basis of the acquired sensing information and
select video content to be displayed on the display from two or more pieces of video content having been generated on a basis of the measured viewing time of each of the users, and causes the display to display the selected video content.

4. A content display method comprising:
acquiring sensing information of a sensor that observes a viewing area that is an area where a display is viewable;
identifying each of two or more users present in the viewing area on a basis of the acquired sensing information, and transmitting identification information of each of the users to a personal authentication server that records personal information;
acquiring personal information corresponding to identification information of each of the users from the personal information recorded in the personal authentication server;
determining one or more video content to be included in video content in accordance with each piece of personal information corresponding to personal information of each user, as video content corresponding to each user;
generating two or more video content including the one or more video content;
causing the display to display each piece of the video content having been generated;
repeating processing of randomly selecting video content to be displayed on the display from two or more pieces of the video content having been generated; and
causing the display to display the selected video content.
